(19) United States
(12) Patent Application Publication
(10) Pub. No.: US 2026/0141796 A1
(43) Pub. Date: May 21, 2026

(54) COMPUTERIZED SYSTEMS AND METHODS FOR SAFETY AND SECURITY MONITORING AND ALERT NOTIFICATION

(71) Applicant: RESIDEO LLC, Golden Valley, MN (US)

(72) Inventors: Kang Zhang, Golden Valley (MN); Louis Tremblay, Golden Valley (MN); James Woolaway, Carbondale, CO (US); Varun Khanna, Golden Valley, MN (US)

(73) Assignee: RESIDEO LLC, Golden Valley, MN (US)

(21) Appl. No.: 19/126,872

(22) PCT Filed: Nov. 8, 2023
(86) PCT No.: PCT/US2023/079046

§ 371 Date: May 2, 2025

Related U.S. Application Data
(60) Provisional application No. 63/382,750, filed on Nov. 8, 2022.

(51) Int. Cl. G08B 21/04; G08B 25/01; G08B 25/14

(52) U.S. Cl. CPC G08B 21/0423; G08B 21/0492; G08B 25/016; G08B 25/14

(57) ABSTRACT

Disclosed are systems and methods that provide a novel framework for centralized management of a user's location based on detected, analyzed and monitored behaviors that can be compared against real-world activities to determine the security and safety of a user. The disclosed framework can operate via an Internet of Things (IoT) configuration that enables the collective management of a location based on the sensors available from each smart device operating therein. The framework can operate as a centralized security panel(s) that can collect sensor data from smart devices/appliances in/around the location. This data can be utilized to generate and/or determine patterns of activity of a user, which can be leveraged to ensure that the user is not engaged in a dangerous activity.

### CROSS REFERENCE TO RELATED APPLICATIONS

This application claims the benefit of, and priority to, U.S. Provisional Patent Application No. 63/382,750 filed Nov. 8, 2022, its entirety of which is incorporated herein by reference.

### FIELD OF THE DISCLOSURE

The present disclosure is generally related to a security monitoring system, and more particularly, to a decision intelligence (DI)-based computerized framework for deterministically monitoring the safety and security of a user(s) at a location BACKGROUND Conventional mechanisms, protocols and implementations of modern security systems are mostly driven by security sensors detecting specific events. For example, the opening or closing of a door by a security contact sensor. In another example, the detection of an object moving within a location when the system is armed by a motion detection sensor. Thus, when a sensor detects an event, the security system can trigger an alarm.

### SUMMARY OF THE DISCLOSURE

According to some embodiments, the disclosed systems and methods provide a novel computerized security framework that provides a more integrated management of a user's safety within a location. In some embodiments, a location can refer to, but is not limited to, a building, home, office, yard, and the like, or any other definable physical/geographic location. For example, a location can be a house.

As discussed herein, the disclosed systems and methods provide an Internet of Things (IoT)-based framework that enables the collective management of a location based on the sensors available from each device and smart device operating therein. For example, the disclosed framework can operate as a centralized security panel(s) that can collect sensor data from smart devices/appliances in/around the location. For example, such sensor data and/or devices can include, but are not limited to, glass break detectors, motion detectors, door and window contacts, heat and smoke detectors, passive infrared (PIR) sensors, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof.

Thus, as discussed herein, the disclosed systems and methods provide a centralized management of a user's location based on detected, analyzed and monitored behaviors that can be compared against learned real-world activities to determine the security and safety of a user.

By way of non-limiting example, when a user trips and falls in their home, conventional systems may not be able to detect that the user is in peril. As discussed above, conventional systems operate on a contingency that is entirely interaction based (e.g., did a user trip the alarm or request assistance). With the advent of the disclosed technology, the disclosed security technology can detect that the user has varied from a determined pattern of behavior, and/or has performed an activity that presents as an activity connected to a dangerous situation (e.g., falling, not moving due to being injured, for example). This detection can then trigger an alarm, which can be specifically transmitted to an appropriate user (e.g., family member and/or first responder).

According to some embodiments, a method is disclosed for a DI-based computerized framework for deterministically monitoring the safety and security of a user(s) at a location. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for a DI-based computerized framework for deterministically monitoring the safety and security of a user(s) at a location.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary data flow according to some embodiments of the present disclosure;

FIG. 4 illustrates an exemplary data flow according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4th or 5th generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed systems and methods provide advanced mechanisms for enabling a security system to monitor a location (e.g., a house of a user, for example). It should be understood that while the discussion herein references a user, this represents a person engaging and/or using a security system.

In conventional systems, as discussed above, security alerts and/or mechanisms for monitoring a location are entirely tied to sensors detecting events tied to a user interaction. For example, when an alarm is active, when a window is opened, a window contact sensor can detect an unwanted activity.

However, conventional security systems are agnostic as to maintaining the general well-being of the users they are designed to protect. That is, there is more to securing a user's safety in their home, for example, than making sure a trespassing does not occur. As discussed herein, according to some embodiments, the disclosed framework is configured to monitor the activities of a user in/around a location in order to ensure their health, safety and well-being.

According to some embodiments, the disclosed systems and methods can enable sensors associated with a security system, as well as sensors associated with smart devices in/around a location to collect data about a user(s). The collected data can be analyzed, whereby a determined set of behavioral patterns for the user can be generated. For example, the user typically is doing X from the hours of Y and Z in room ABC. This baseline of activity can be leveraged to ensure that the user is not acting out of the ordinary according to the user's routine(s).

In some embodiments, the collected sensor data can further be utilized to determine that sudden or random actions of the user are not associated with events where the user is in danger. For example, if it is midday, and the user is detected as being motionless on their floor for more than a threshold period of time (e.g., 15 minutes), and it is generally known that the user does not take naps during that time period, the disclosed framework can be configured to trigger an alarm that facilitates assistance for the user. Thus, even when a user is not capable of triggering an alarm (and/or the system is not “armed” to prevent intruders), the disclosed framework can operate to ensure the well-being of the user.

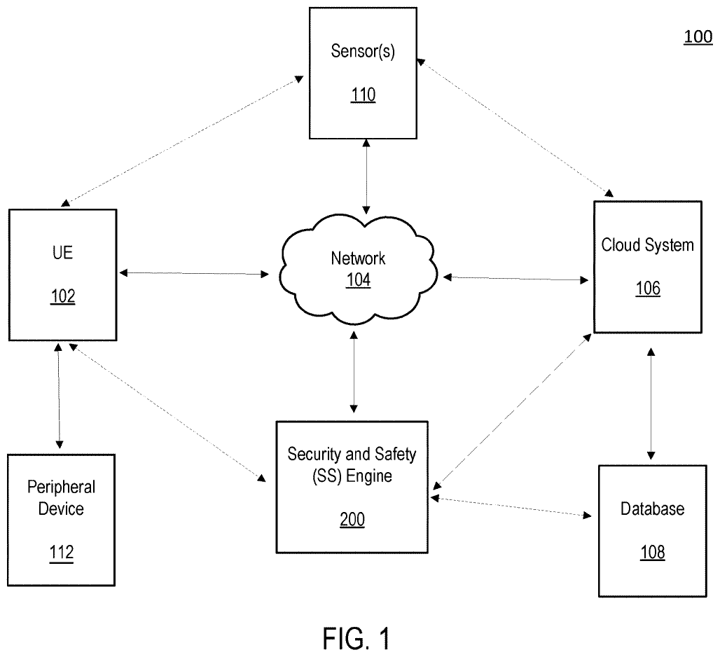

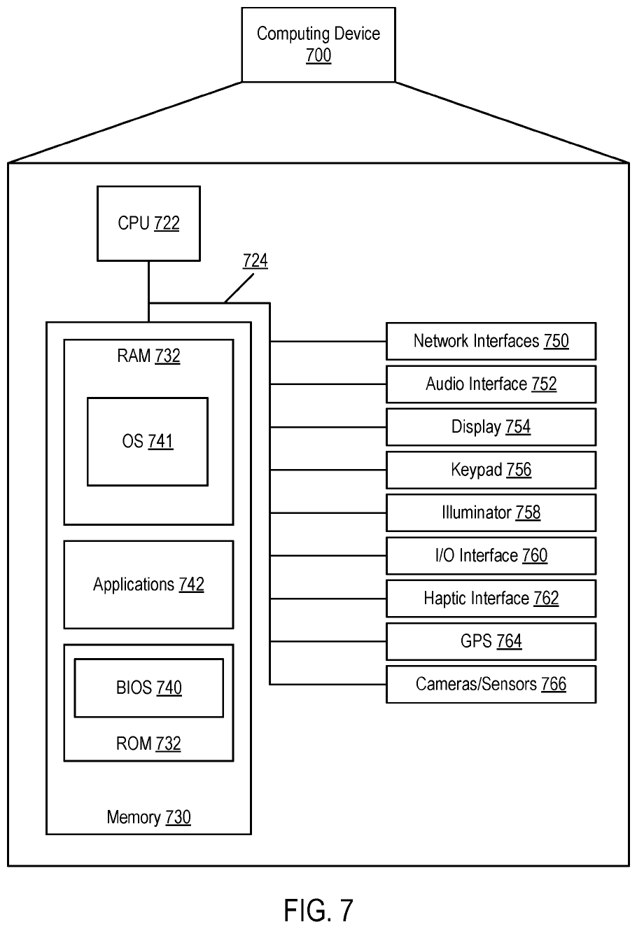

With reference to FIG. 1, system 100 is depicted which includes UE 102 (e.g., a client device, as mentioned above and discussed below in relation to FIG. 7), sensors 110, network 104, cloud system 106, database 108, security and safety (SS) engine 200 and peripheral device 112. It should be understood that while system 100 is depicted as including such components, it should not be construed as limiting, as one of ordinary skill in the art would readily understand that varying numbers of UEs, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IOT) device, autonomous machine, and any other device equipped with a cellular or wireless or wired transceiver. In some embodiments, UE 102 can be a device associated with an individual (or set of individuals) for which security services are being provided. In some embodiments, UE 102 may correspond to a device of a security entity (e.g., a security provider, whereby the device is a security panel and has corresponding sensors 110, as discussed herein).

In some embodiments, peripheral device 112 can be connected to UE 102, and can be any type of peripheral device, such as, but not limited to, a wearable device (e.g., smart watch), printer, speaker, sensor, and the like. In some embodiments, peripheral device 112 can be any type of device that is connectable to UE 102 via any type of known or to be known pairing mechanism, including, but not limited to, Bluetooth™, Bluetooth Low Energy (BLE), NFC, and the like.

According to some embodiments, a sensors 110 can correspond to sensors associated with a location of system 100. In some embodiments, the sensors 110 can be associated with security sensors, such as, for example, cameras, glass break detectors, motion detectors, door and window contacts, heat and smoke detectors, passive infrared (PIR) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. For example, the sensors 110 can include the sensors on UE 102 (e.g., smart phone) and/or peripheral device 112 (e.g., a paired smart watch).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a security system provider, which has associated network resources hosted on the internet or private network (e.g., network 104), which enables (via engine 200) the security management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of UE 102/device 112 and the UE 102/device 112, sensors 110, and the services and applications provided by cloud system 106 and/or SS engine 200.

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

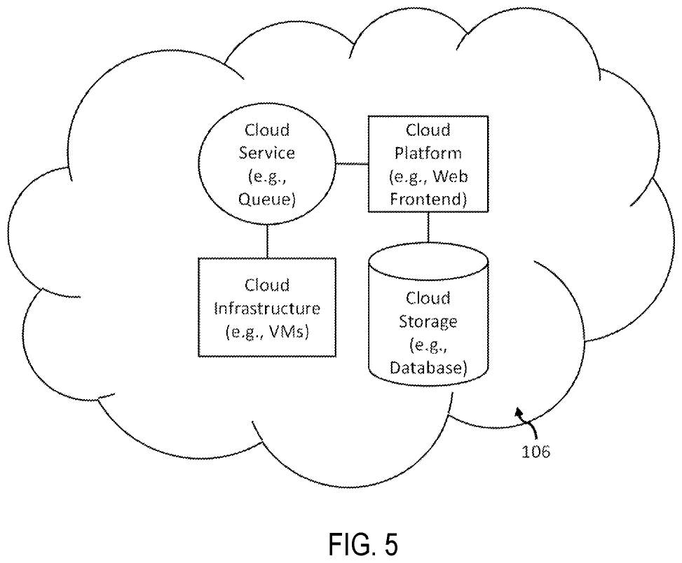

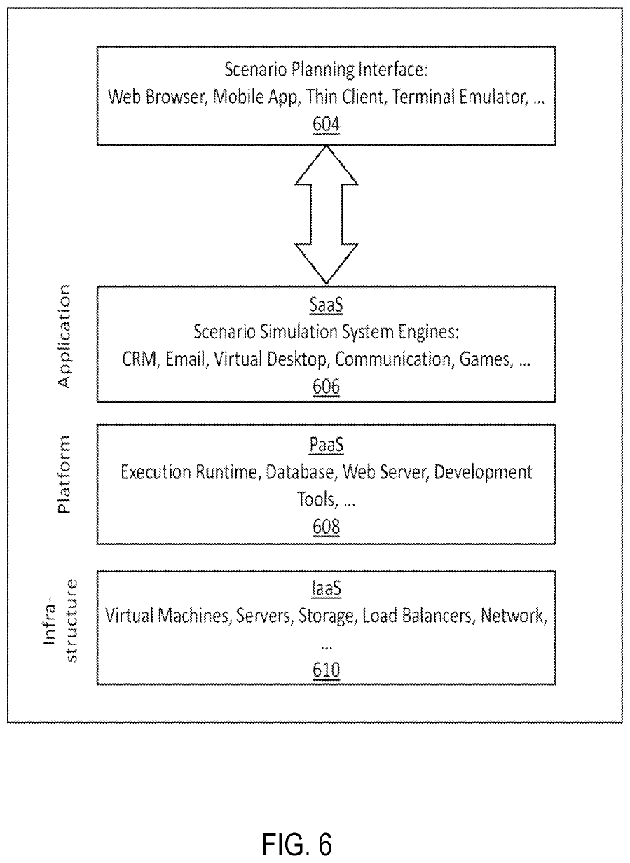

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 120 such as, but not limiting to: infrastructure a service (IaaS) 610, platform as a service (PaaS) 608, and/or software as a service (Saas) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted APIs of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL).

According to some embodiments, database 108 may correspond to a distributed ledger of a distributed network. In some embodiments, the distributed network may include a plurality of distributed network nodes, where each distributed network node includes and/or corresponds to a computing device associated with at least one entity (e.g., the entity associated with cloud system 106, for example, discussed supra). In some embodiments, each distributed network node may include at least one distributed network data store configured to store distributed network-based data objects for the at least one entity. For example, database 108 may correspond to a blockchain, where the distributed network-based data objects can include, but are not limited to, account information, medical information, entity identifying information, wallet information, device information, network information, credentials, security information, permissions, identifiers, smart contracts, transaction history, and the like, or any other type of known or to be known data/metadata related to an entity's and/or user's information, structure, business and/or legal demographics, inter alia.

In some embodiments, a blockchain may include one or more private and/or private-permissioned cryptographically-protected, distributed databased such as, without limitation, a blockchain (distributed ledger technology), Ethereum (Ethereum Foundation, Zug, Switzerland), and/or other similar distributed data management technologies. For example, as utilized herein, the distributed database(s), such as distributed ledgers ensure the integrity of data by generating a digital chain of data blocks linked together by cryptographic hashes of the data records in the data blocks. For example, a cryptographic hash of at least a portion of data records within a first block, and, in some cases, combined with a portion of data records in previous blocks is used to generate the block address for a new digital identity block succeeding the first block. As an update to the data records stored in the one or more data blocks, a new data block is generated containing respective updated data records and linked to a preceding block with an address based upon a cryptographic hash of at least a portion of the data records in the preceding block. In other words, the linked blocks form a blockchain that inherently includes a traceable sequence of addresses that may be used to track the updates to the data records contained therein. The linked blocks (or blockchain) may be distributed among multiple network nodes within a computer network such that each node may maintain a copy of the blockchain. Malicious network nodes attempting to compromise the integrity of the database must recreate and redistribute the blockchain faster than the honest network nodes, which, in most cases, is computationally infeasible. In other words, data integrity is guaranteed by the virtue of multiple network nodes in a network having a copy of the same blockchain. In some embodiments, as utilized herein, a central trust authority for sensor data management may not be needed to vouch for the integrity of the distributed database hosted by multiple nodes in the network.

In some embodiments, exemplary distributed blockchain-type ledger implementations of the present disclosure with associated devices may be configured to affect transactions involving Bitcoins and other cryptocurrencies into one another and also into (or between) so-called FIAT money or FIAT currency, and vice versa.

In some embodiments, the exemplary distributed blockchain-type ledger implementations of the present disclosure with associated devices are configured to utilize smart contracts that are computer processes that facilitate, verify and/or enforce negotiation and/or performance of one or more particular activities among users/parties. For example, an exemplary smart contract may be configured to be partially or fully self-executing and/or self-enforcing. In some embodiments, the exemplary inventive asset-tokenized distributed blockchain-type ledger implementations of the present disclosure may utilize smart contract architecture that may be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. For example, each node may also check the work of other nodes and in some cases, as noted above, function as miners or validators.

SS engine 200, as discussed above and further below in more detail, can include components for the disclosed functionality. According to some embodiments, SS engine 200 may be a special purpose machine or processor, and can be hosted by a device on network 104, within cloud system 106 and/or on UE 102 (and/or peripheral device 112). In some embodiments, engine 200 may be hosted by a server and/or set of servers associated with cloud system 106.

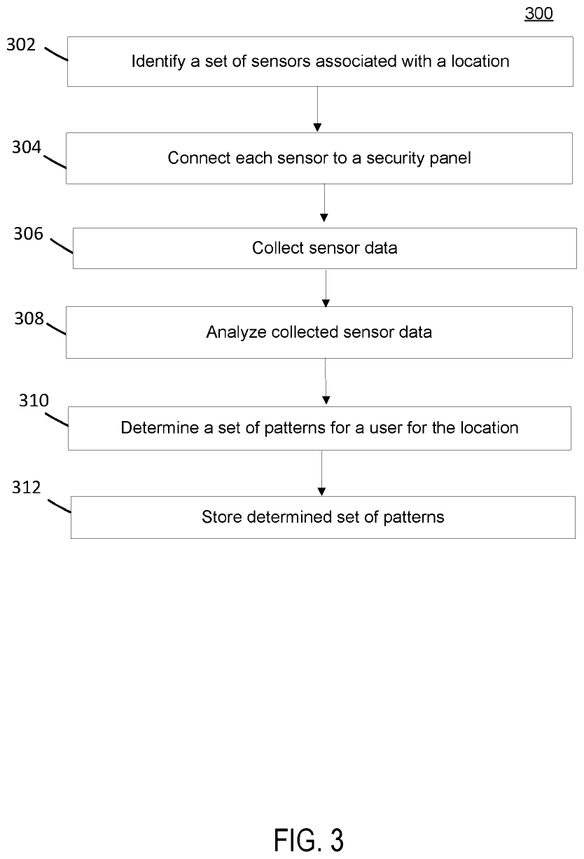

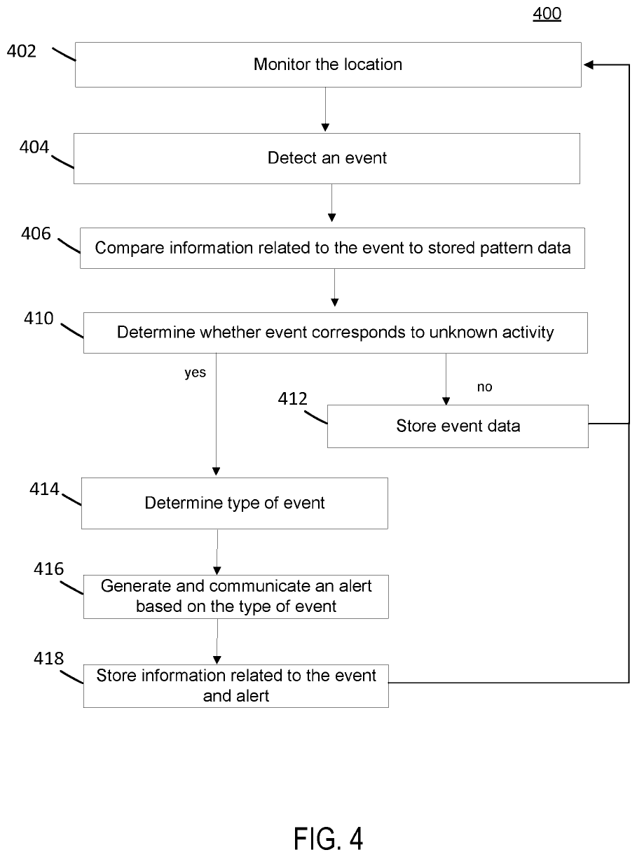

According to some embodiments, as discussed in more detail below, SS engine 200 may be configured to implement and/or control a plurality of services and/or microservices, where each of the plurality of services/microservices are configured to execute a plurality of workflows associated with performing the disclosed security management. Non-limiting embodiments of such workflows are provided below in relation to at least FIGS. 3-4.

According to some embodiments, as discussed above, SS engine 200 may function as an application provided by cloud system 106. In some embodiments, engine 200 may function as an application installed on a server(s), network location and/or other type of network resource associated with system 106. In some embodiments, engine 200 may function as application installed and/or executing on UE 102. In some embodiments, such application may be a web-based application accessed by UE 102 and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on UE 102 and/or sensors 110.

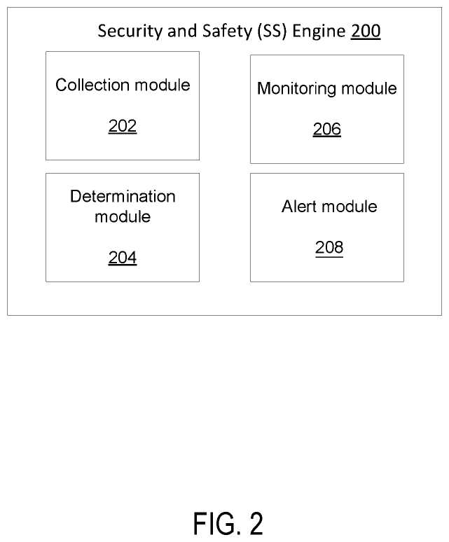

As illustrated in FIG. 2, according to some embodiments, SS engine 200 includes collection module 202, determination module 204, monitoring module 206 and alert module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed security management framework.

According to some embodiments, Steps 302-306 of Process 300 can be performed by collection module 202 of SS engine 200; and Steps 308-312 can be performed by determination module 204.

According to some embodiments, Process 300 begins with Step 302 where a set of sensors for a location are identified. According to some embodiments, the sensors can be associated with security sensors (e.g., glass break, window contact, motion detection, and the like, as discussed above). In some embodiments, the sensors can be associated with devices in/around the location. For example, a smart watch's fall detection enabled via gyroscope and/or accelerometer data associated with the smart watch and/or connected smart phone. Additional, non-limiting examples of sensors and the types of collectable data are discussed above at least in relation to FIG. 1.

In Step 304, the identified set of sensors can be connected to engine 200. According to some embodiments, engine 200 can operate as a centralized “security panel” for a location. Thus, in some embodiments, Step 304 can involve the configuration of each identified sensor and its pairing/connection with engine 200 and/or each other. Accordingly, in some embodiments, with reference to FIG. 1, for example, sensors 110 can be paired with each other, with engine 200 and/or UE 102, which can be paired via connectivity protocols provided and/or enabled via engine 200. For example, a security sensor 110 can be paired/connected with another sensor 110, engine 200 and/or UE 102 via BLE technology. In some embodiments, the sensors 110 can be paired and/or connected with another sensor 110, engine 200 and/or UE 102 via a physical wire connection (e.g., fiber, ethernet, coaxial, and/or any other type of known or to be known wiring to hardwire a home for network connectivity for devices operating therein). In some embodiments, the sensors 110 can be paired/connected with another sensor 110, engine 200 and/or UE 102 via a cloud-to-cloud (C2C) connection (e.g., establish connection with a third party cloud, which connects with cloud system 106, for example). In some embodiments, the sensors 110 can be paired/connected via a combination of network capabilities, hard wiring and/or C2C. In some embodiments, the sensors 110 can be paired so as enable an extended reach of the sensor's configuration to detect specific types of events.

In Step 306, engine 200 can operate to trigger the identified sensors to begin collecting sensor data. According to some embodiments, the sensor data can be collected continuously and/or according to a predetermined period of time or interval. In some embodiments, sensor data may be collected based on detected events. In some embodiments, type and/or quantity of sensor data may be directly tied to the type of sensor. For example, a window contact sensor may only collect sensor data when a window is opened (e.g., an open event, which can indicate, but is not limited to, the identity of the window, time of opening, time of closing, duration of opening, quantity of opening, and the like, or some combination thereof). In another non-limiting example, a gyroscope sensor on a user's smartphone can detect when a user is moving, the type and/or metrics of such movements.

In some embodiments, the collected sensor data in Step 306 can be stored in database 108 in association with an identifier (ID) of a user, location and/or account of the user/location.

In Step 308, engine 200 can analyze the collected sensor data. According to some embodiments, engine 200 can implement any type of known or to be known computational analysis technique, algorithm, mechanism or technology to analyze the collected sensor data from Step 306.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

By way of a non-limiting example, engine 200 can implement an XGBoost algorithm for regression and/or classification to analyze the sensor data, as discussed herein.

According to some embodiments, the AI/ML computational analysis algorithms implemented can be applied and/or executed in a time-based manner, in that collected sensor data for specific time periods can be allocated to such time periods so as to determine patterns of activity (or non-activity) according to a criteria. For example, engine 200 can execute a Bayesian determination for a 24 hour span every 8 hours, so as to segment the day according to applicable patterns, which can be leveraged to determine, derive, extract or otherwise activities/non-activities in/around a location.

In some embodiments and, optionally, in combination of any embodiment described above or below, a neutral network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 310, based on the analysis from Step 308, engine 200 can determine a set of patterns for a user for the location. According to some embodiments, the determined patterns are based on the computational AI/ML analysis performed via engine 200, as discussed above.

In some embodiments, the set of patterns can correspond to, but are not limited to, types of events, types of detected activity, a time of day, a date, type of user, duration, amount of activity, quantity of activities, sublocations within the location (e.g., rooms in the house, for example), and the like, or some combination thereof.

For example, a specified pattern of activity for a user may correspond to a specific day of the week, and a specific time. For example, a pattern may correspond to “morning routine” of a user from 6 AM to 7:30 AM, on a Monday, whereby the user is determined as waking up from sleep, walking into the kitchen to make coffee, then moving back to their bedroom to get dressed and leave for work. The pattern can correspond to and/or indicate specific routes within the location (e.g., which rooms are entered and exited, hallways used, and in which order, for example).

In Step 312, engine 200 can store the determined set of patterns in database 108, in a similar manner as discussed above. According to some embodiments, Step 312 can involve creating a data structure associated with each determined pattern, whereby each data structure can be stored in a proper storage location associated with an identifier of the user/location, as discussed above.

In some embodiments, a pattern can comprise a set of events, which can correspond to an activity and/or non-activity (e.g., exercising in the house, cleaning the dishes, sleeping, and the like, for example). In some embodiments, the pattern's data structure can be configured with header (or metadata) that identifies a user or the location, and/or a time period/interval of analysis (as discussed above in relation to Step 306); and the remaining portion of the structure providing the data of the activity/non-activity. In some embodiments, the data structure for a pattern can be relational, in that the events of a pattern can be sequentially ordered, and/or weighted so that the order corresponds to events with more or less activity.

In some embodiments, the structure of the data structure for a pattern can enable a more computationally efficient (e.g., faster) search of the pattern to determine if later detected events correspond to the events of the pattern, as discussed below in relation to at least Steps 406-408 of Process 400 of FIG. 4.

In some embodiments, the data structures of patterns can be, but are not limited to, files, arrays, lists, binary, heaps, hashes, tables, trees, and the like, and/or any other type of known or to be known tangible, storable digital asset, item and/or object.

According to some embodiments, the sensor data can be identified and analyzed in a raw format, whereby upon a determination of the pattern, the data can be compiled into refined data (e.g., a format capable of being stored in and read from database 108). Thus, in some embodiments, Step 312 (and/or Step 310) can involve the creation and/or modification (e.g., transformation) of the sensor data into a storable format.

In some embodiments, as discussed below, each pattern (and corresponding data structure) can be modified based on further detected behavior, as discussed below in relation to Process 400 of FIG. 4.

Turning to FIG. 4, Process 400 provides non-limiting example embodiments for the deployment and/or implementation of the disclosed security management framework.

According to some embodiments, Steps 402-404 of Process 400 can be performed by monitoring module 206 of SS engine 200; Steps 406-414 can be performed by determination module 204; and Steps 416-418 can be performed by alert module 208.

According to some embodiments, Process 400 begins with Step 402 where engine 200 monitors the location. As discussed above, the location can correspond to a predefined physical/geographic location (e.g., a house or building).

In some embodiments, engine 200 can monitor the location continuously, and/or according to a predetermined time interval. In some embodiments, the monitoring of the location can be performed via the location's sensors in a similar manner as discussed above at least in relation to Step 306 of Process 300, discussed supra. In some embodiments, the monitoring can involve periodically pinging each or a portion of the sensors at the location, and awaiting a reply. In some embodiments, the monitoring can involve push and/or fetch protocols to collect sensor data from each sensor.

In Step 404, based on the monitoring of the location, engine 200 can detect an event. In some embodiments, the detection of the event can involve a sensor or sensors at the location (e.g., that are connected via Step 302 of Process 300, discussed supra) detecting sensor data for an event, and electronically communicating that sensor data via the established connection with engine 200, as discussed above.

In some embodiments, an event can correspond to activity at the location (e.g., a user moving, an item moving, a pet moving, and the like). In some embodiments, the activity may have to be performed according to a criteria including, but not limited to, be a particular size, movements for a predetermined period of time (e.g., 3 seconds), movements at a certain speed (e.g., velocity and/or acceleration), movements at certain angles and/or trajectories, a time, a date, a location within the location (e.g., a sub-location), and the like, or some combination thereof.

In some embodiments, the event can also, or alternatively, correspond to non-activity, which can correspond to a criteria related to, but not limited to, lack of movement of a user, item or other identifiable object for a predetermined period of time, a time, a date, a location within the location (e.g., a sub-location), and the like, or some combination thereof. For example, a user is detected in the kitchen of the house, and is determined to not be moving for 10 minutes during lunch time.

In Step 406, engine 200 can analyze the detected event information by comparing the event information to the stored pattern data for that location and/or user. In some embodiments, such analysis can be performed in a similar manner as discussed above at least in relation to Step 308 of Process 300 of FIG. 3.

In some embodiments, engine 200 can perform the comparison (and determination of Step 408) based on a similarity analysis, whereby an activity and/or derivation from known activities can be analyzed to determine whether the event data is substantially similar, based on a similarity threshold, to known activities.

According to some embodiments, engine 200 can implement any known or to be known similarity algorithm, technique or mechanism to perform such similarity determination, including, but not limited to, feature vector analysis, decision trees, boosting, support-vector machines, neural networks, nearest neighbor algorithms, Naive Bayes, bagging, random forests, logistic regression, and the like.

For example, an event can be translated to an n-dimensional feature vector, whereby a comparison between nodes of the feature vector of the event may be compared to nodes of feature vectors of the determined patterns for the user/location. Should the similarity values be at or above a threshold, then a similar event may have been detected.

By way of a non-limiting example, considering the above “morning routine” example, if the user is determined to not be moving (for a threshold satisfying amount of time-for example, 15 minutes) on a Monday morning between 6 AM to 7:30 AM, and/or the sensors detect random activities (e.g., another person is detected that does not have the corresponding attributes of the known user, the user is moving a threshold amount of speed faster than normal, or slower than normal, the user is entering and remaining in rooms not traditionally visited during this time period/day, and the like), the comparison can yield a detected event that corresponds to unknown activity, which can trigger an alert/alarm, as discussed below.

Accordingly, engine 200 can perform the analysis (and subsequent determination discussed below in relation to Step 408) in a similar manner as discussed above at least in relation to Steps 306 and 308 of Process 300 of FIG. 3, discussed supra.

In Step 408, based on the comparison/analysis from Step 406, engine 200 can determine whether the event detected in Step 404 corresponds to unknown activity.

In some embodiments, when the event is determined to correlate to known activity (e.g. it corresponds to at least one activity within a previously determined pattern of the user), Process 400 can proceed to Step 412, where the event data can be stored (e.g., so that the pattern can be updated). In some embodiments, such storage can involve the creation of a new data pattern data structure; and in some embodiments, such storage can involve the modification of an existing pattern data structure to include the updated event data (e.g., update the “morning routine” data structure”, for example). In some embodiments, the event data can be further utilized to train engine 200 to determine corresponding events for future events.

Accordingly, engine 200 may then continue monitoring the location. In some embodiments, the monitoring does not stop upon detection of an event, but continues running in the backend (e.g., monitoring module 206), while certain modules of engine 200 analyze each detected event.

In some embodiments, when the event is determined to be unknown (e.g., not be at least a threshold amount of similarity to at least one activity of a determined pattern), Process 400 can proceed from Step 410 to Step 414.

In Step 414, engine 200 can analyze the event data/information, and determine the type of event. In some embodiments, such event type determination can be based on, but not limited to, type of sensor providing an indication of the event, a number of sensors triggered, activity that triggered the event, time of the event, date of the event, and the like, or some combination thereof.

In Step 416, engine 200 can generate an alert based on the type of event. For example, if the event corresponds to a fall by the user, then the alert may correspond to a medical emergency. In another example, if the event is a fire, then the alert may correspond to a fire emergency.

Thus, in some embodiments, Step 416 can then communicate the generated alert based on the type of alert. For example, for a fire emergency alert, the local fire department may be notified (in addition to the security system being activated and the alarm optionally playing at the location).

In some embodiments, the alert can be configured as individual provided alerts and/or a set of alerts. In some embodiments, the alert(s) can be configured as, but not limited to, SMS messages, notifications (e.g., push messages) on an application associated with engine 200, phone calls, chat messages, emails, and the like, or some combination thereof.

According to some embodiments, the alert generated in Step 416 can be directed to a set of emergency contacts associated with the user. Accordingly, in some embodiments, a set of users determined, selected or otherwise identified as being associated with the user can be alerted.

For example, if user X has designated users Y and Z as their contacts (and/or it is known users Y and Z share a home with user X), this information can be stored in database 108. Upon detecting an event respective to user X (e.g., user X has fallen), users Y and Z's information can be retrieved from the database 108 and used to contact them in reference to the event. In some embodiments, upon detection of an event at a location, all (or a portion) of users associated with that location can be alerted. Such alerts can be automated messages, SMS messages, emails, application notifications, and the like, for example. In some embodiments, first responders and other medical, security and fire professionals can be associated with a location.

According to some embodiments, upon a user receiving an alert, if no activity is performed (and/or the alert is dismissed), and/or no input respective to the alert is provided that indicates that the alert was a false alarm or has been remedied, this information can be fed back to engine 200 to alert first responders and/or reset the alarm, and further train the system.

In some embodiments, the alert can first be provided to users associated with a user involved in the event (or users associated with the location and/or designated as contacts of the user/location). After a predetermined period of time has passed (e.g., 15 minutes), if no input has been provided that indicates the alarm is false or has been remedied, central authorities (e.g., the alarm system and/or first responders) can be alerted.

For example, if user Grandpa has fallen, user Grandson may receive an alert. The alert can be a push message and/or an application notification, for example, that automatically is displayed on the device of the Grandson, which requests an action to be performed (e.g., dismiss, contact Grandpa and/or alert first responders, for example). If the alert is not responded to within a predetermined period of time, the police department local to Grandpa's location may be notified.

Accordingly, according to some embodiments, a user or set of users associated with a location signing up for the safety and security services enabled via engine 200 can involve, in addition to establishing an account, electing, selecting and/or identifying a set of emergency contacts. Thus, in some embodiments, the emergency contacts can be associated with a user or users, and/or a location. In some embodiments, upon setting up an account, a user can enable engine 200 access to their contacts (e.g., contact listing on their smartphone or within their email account, for example), which can be leveraged for the notifications of events/alarms, as discussed herein.

In some embodiments, the selected/identified contacts can be set in a preferred order, which can be set by the user, an administrator, engine 200, or some combination thereof. For example, if the user selects three (3) users as emergency contacts, they can be identified according to an order of which contacts to alert first in the instance of an emergency. In some embodiments, a setting/preference can be applied to alert all contacts or a portion of contacts, either in order or simultaneously.

In some embodiments, first responders can be configured to be alerted according to an order, which can be after contacting central authorities (e.g., the security system provider), prior to central authorities, or simultaneously.

In some embodiments, a contact to be alerted can be discovered based on proximity and/or relationship to a user (and/or location). In some embodiments, another user (which may be a subscriber to the security service discussed herein) may be identified based on their geographic and/or relationship proximity to the user and/or location. For example, if another user is determined to be a neighbor (e.g., next door, or living on same street or within same building, for example), that user can be delineated automatically as a contact (or as a back-up contact should the user's selected contacts not be available or responsive to alerts).

In another example, if the other user is determined to have a relationship with the user (e.g., is a family member), then that user can be identified as a contact. For example, the user's social media platforms may be mined for such information (e.g., are they “family” or “friends” (e.g., for a predetermined period of time) and/or live or have previously in the same geographic area, for example)

And, in yet another non-limiting example, another user can be identified if they are determined to have a relationship with the location. For example, if the other user is a superintendent, security guard or works at the location (e.g., gardener, for example), they can be identified as a contact.

In Step 418, the information related to the event and the alert can be stored. According to some embodiments, the data determined, generated, derived or otherwise identified from Steps 414-418 can be stored and used to further train engine 200 in a similar manner as discussed above. For example, data related to false alerts and/or feedback from the notified users of alerts (e.g., from Step 416) can be recursively fed back to the AI/ML algorithms executed by engine 200 for further training to increase the accuracy and efficiency of detected emergency events. For example, if a contact receives a notification that a user is potentially in a dangerous situation (e.g., an alert as per Step 416, discussed above), and the contact dismisses this as a false alarm (e.g., knowing that the alert is not serious (for example, having just spoken to the user on the telephone), then the event data can be categorized as a “false alarm” and used to train the model executing by engine 200 for that location/user.

According to some embodiments, a location can have a dedicated engine 200 model so that the security and safety protocols applied to the location can be specific to the events and patterns learned and detected at that location. In some embodiments, the model can be specific for a user or set of users (e.g., users that live at a certain location (e.g., a house), and/or are within a proximity to each other (e.g., live on the same street, for example)).

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 102 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, Javascript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, via an application executed by at least one processor associated with a location, a set of sensors associated with the location;
connecting, via the application, over a network, to each of the set of sensors;
collecting, via the application, sensor data from each connected sensor;
analyzing, via the application, the collected sensor data;
determining, via the application, a pattern of activity for a user at the location;
storing, via the application, the determined pattern of activity; and
performing monitoring, via the application, of the location based on the stored pattern of activity.

2. The method of claim 1, wherein the at least one processor is associated with a device located at the location.

3. The method of claim 2, wherein the device is associated with a security panel installed at the location, the security panel being associated with a security provider for the location, wherein the security provider is a provider of the application.

4. The method of claim 2, wherein the device is device of the user.

5. The method of claim 1, wherein the at least one processor is associated with a cloud accessible via the network.

6. The method of claim 1, wherein the set of sensors comprise sensors associated with at least one of security sensors and smart sensors of devices at the location.

7. The method of claim 1, wherein the location is a geographically defined physical location.

8. The method of claim 7, wherein the location is a building.

9. A method comprising:
monitoring, via an application executed by at least one processor associated with a location, the location for detection of an event, the location having associated therewith a known pattern of activity for at least one user at the location;
detecting, via the application, based on the monitoring of the location, the event; and
determining, via the application, whether the event corresponds to the pattern of activity, wherein:
when the event is determined to be an unknown event, triggering, via the application, an alarm, and
when the event is determined to be a known event, updating, via the application, the pattern to account for the event.

10. The method of claim 9, further comprising:
identifying at least one other user associated with at least one of the user and location;
generating an electronic message corresponding to the alert; and
communicating the electronic message to a device of the at least one other user.

11. The method of claim 10, further comprising:
determining, based on an action or non-action performed by the at least one other user to alert authorities; and
automatically communicating an alert to the authorities based on the determined action or non-action.

12. The method of claim 11, wherein the automatic communication occurs upon non-action after a predetermined period of time has elapsed from delivery of the electronic message.

13. A device comprising:
at least one processor configured to:
identify, via an executed application, a set of sensors associated with a location;
connect, via the application, over a network, to each of the set of sensors;
collect, via the application, sensor data from each connected sensor;
analyze, via the application, the collected sensor data;
determine, via the application, a pattern of activity for a user at the location;
store, via the application, the determined pattern of activity; and
perform monitoring, via the application, of the location based on the stored pattern of activity.

14. A device comprising:
at least one processor configured to:
monitor, via an executed application, a location for detection of an event, the location having associated therewith a known pattern of activity for at least one user at the location;
detect, via the application, based on the monitoring of the location, the event; and
determine, via the application, whether the event corresponds to the pattern of activity, wherein:
when the event is determined to be an unknown event, triggering, via the application, an alarm, and
when the event is determined to be a known event, updating, via the application, the pattern to account for the event.

15. A non-transitory computer-readable storage medium tangibly encoded with computer-executable instructions that when executed by at least one processor, perform a method comprising:
identifying, via an application executed by the at least one processor, a set of sensors associated with a location, the at least one processor associated with the location;
connecting, via the application, over a network, to each of the set of sensors;
collecting, via the application, sensor data from each connected sensor;
analyzing, via the application, the collected sensor data;
determining, via the application, a pattern of activity for a user at the location;
storing, via the application, the determined pattern of activity; and
perform monitoring, via the application, of the location based on the stored pattern of activity.

16. A non-transitory computer-readable storage medium tangibly encoded with computer-executable instructions that when executed by at least one processor, perform a method comprising:
monitoring, via an application executed by the at least one processor, a location for detection of an event, the location having associated therewith a known pattern of activity for at least one user at the location, the at least one processor associated with the location;
detecting, via the application, based on the monitoring of the location, the event; and
determining, via the application, whether the event corresponds to the pattern of activity, wherein:
when the event is determined to be an unknown event, triggering, via the application, an alarm, and
when the event is determined to be a known event, updating, via the application, the pattern to account for the event.
